(19) United States
(12) Patent Application Publication
(10) Pub. No.: US 2013/0211298 A1
(43) Pub. Date: Aug. 15, 2013

(54) ACTIVE DEVICE FOR PERINEAL STIMULATION

(71) Applicant: Maria Olga Polo Eguia, Llodio (ES)

(72) Inventor: Maria Olga Polo Eguia, Llodio (ES)

(21) Appl. No.: 13/879,181

(22) PCT Filed: Oct. 13, 2010
(86) PCT No.: PCT/ES2010/070659

§ 371 Date: Apr. 12, 2013

(51) Int. Cl. A61H 19/00; A61H 23/00

(52) U.S. Cl. CPC A61H 19/40; A61H 23/00
USPC 601/46

(57) ABSTRACT

Active device to stimulate a perineal area, configured to be inserted in a vagina having a hollow body which in turn includes an upper segment, a lower segment which has a longitudinal axis between the upper segment and the lower segment; an inner wall; vibration elements for making the inner wall vibrate; and vibration-transmission elements to transmit the vibration from the vibration elements to the inner wall so that the inner wall is alternatively vibrated by the vibration elements.

### FIELD OF THE INVENTION

The invention refers to an active device configured to be inserted in the user's vagina to stimulate the perineal area.

### BACKGROUND OF THE INVENTION

In the state of the art, different devices are known to stimulate the perineal area. For instance, patent application number ES 2251887 shows a mechanical device to stimulate a perineal area, configured to be inserted in a vagina, the device having a hollow body which in turn includes: an upper segment, a lower segment, an inner wall and striking means for striking the inner wall. As it is an active device, it also includes movement-generating means to actuate the striking means; movement-transmission means to transmit movement from the movement-generating means to the striking means, so that the inner wall is struck alternatively by the striking means.

The devices known in the state of the art require some constructively complex mechanisms that lead to the devices being quite heavy and also to complications potentially arising during the use of the devices. Another problem of devices having complex mechanisms with a large number of moving elements is the short duration of the battery.

By contrast, the present invention aims to provide a stimulating device that comprises other components with a simpler embodiment, which provide a correct operation of the device and avoid the problems that the devices known in the art fail to solve.

### DESCRIPTION OF THE INVENTION

The present invention refers to a device which is intravaginally inserted and produces a vibration-based mechanical stimulation of vibration receptors of the vagina and the pelvic floor muscles both in a static situation, when the user is not moving, and in a dynamic situation, when the user is moving.

The device allows for vaginal and pelvic floor muscle tonification, and thus is extremely useful in any pathology associated to the weakness of such muscles (urinary incontinence, sexual dysfunctions, vaginal openings, grade I and II cystoceles, among others), as a postpartum perineal prevention and recovery method, as prevention and recovery method of the perineal hypotonia in women with hyperpressive activity (sports, work-related hyperpressure, chronic cough and other causes) and as a method for maintaining pelvic floor muscles. The solution of the present invention to the problems herein stated is attained by means of a vibration assembly housed in the inner cavity of a body so that, during the use of the device, the inner wall of the body is vibrated, improving vaginal and pelvic floor muscle tonification.

The mechanism inside the device enables to regulate the intensity and frequency of vibration.

### BRIEF DESCRIPTION OF THE DRAWINGS

The following is a brief description of a series of drawings, which will help understand the invention, relating to modalities or variants of said invention which are presented as non-limiting examples thereof.

FIG. 1 is a longitudinal sectional view of a device of the invention which shows different components of the device.

FIG. 2 is an exploded view which shows some components of the device in an embodiment of the invention.

FIG. 3 is an exploded view which shows some components of the device in another embodiment of the invention.

### DETAILED DESCRIPTION OF THE INVENTION

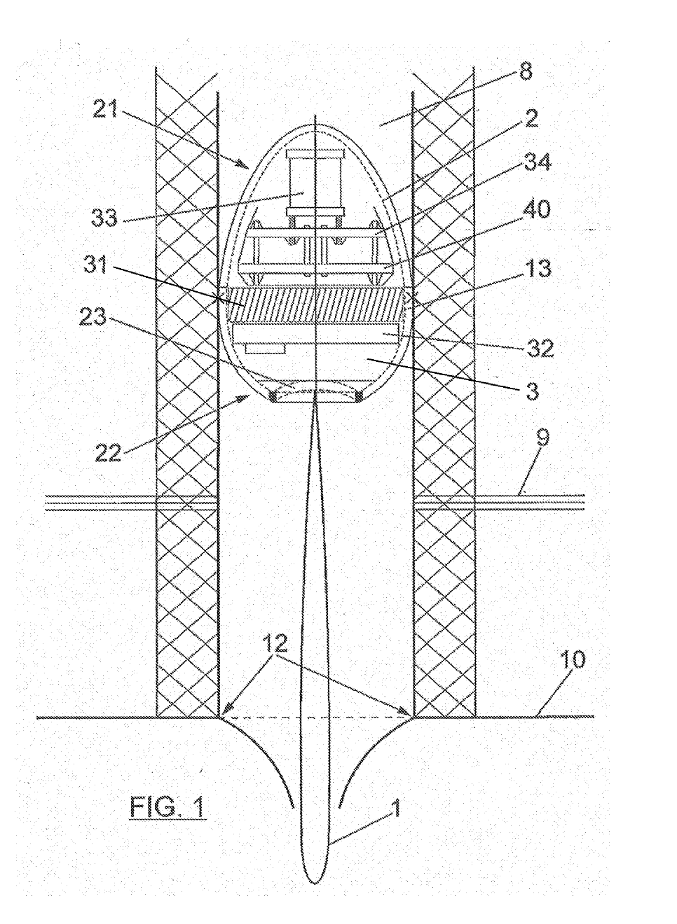

FIG. 1 is a longitudinal sectional view of a first embodiment an active device to stimulate the perineal area according to the invention. The device is shown placed inside the vagina (12) of a user, above the user's pelvic floor (9). The device is kept in place in a passive manner, by the compression of the walls of the vagina (12) and by the muscle tone of the pelvic floor (9), without requiring the patient's active contraction to hold the device in place. The shape and dimensions of the device are configured to favor said passive placing of the device.

The device comprises a ball or hollow body (2), which in turn comprises a cavity (3). Said body (2) further comprises:
an upper segment (21);
a lower segment (22) which has a longitudinal axis between the upper segment (21) and the lower segment (22);
an inner wall (13);
vibration means (30) to make the inner wall (13) vibrate—note that said vibration means (30) are not visible in FIG. 1—, wherein the intensity and frequency of the vibrations can be regulated;
vibration-transmission means (31) to transmit the vibration from the vibration means (30) to the inner wall (13) so that the inner wall (13) is alternatively vibrated by the vibration means (30).

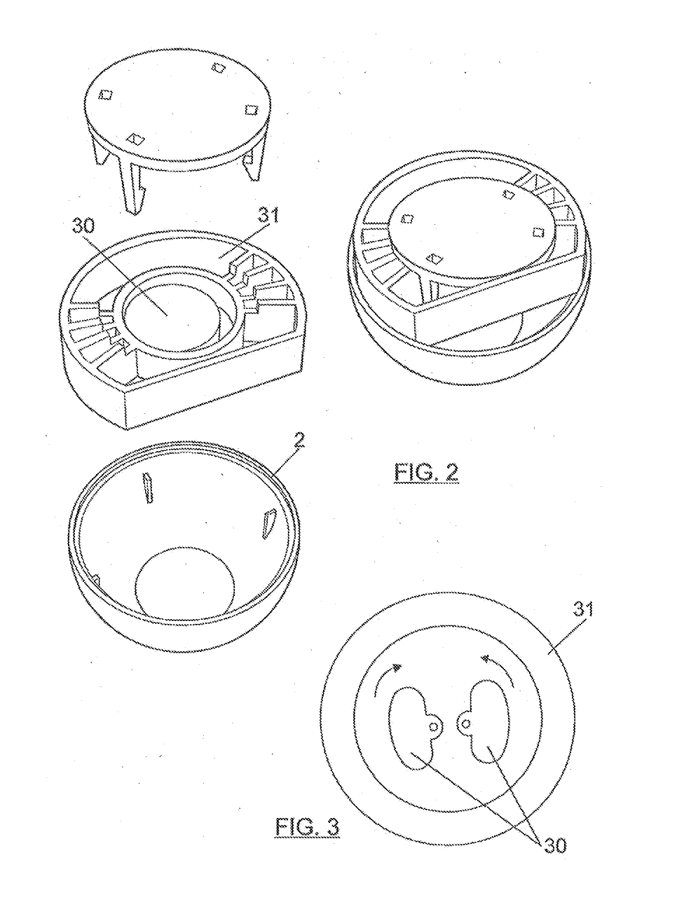

FIG. 2 is an exploded view which shows some components of the device in an embodiment of the invention. An example of a vibration means (30) located inside a vibration-transmission means (31) is shown in the figure.

When the vibration-transmission means (31) transmit the vibration from the vibration means (30) to the inner walls (13) of the ball or hollow body (2), the vaginal and pelvic floor baroreceptors and vibration receptors are stimulated, causing the tonification of the pelvic floor (9) and an increase in the vaginal muscular activity.

As shown in FIG. 3, the vibration means (30) can comprise two eccentric parts capable of rotating in opposite directions, at equal or close speeds.

Optionally, the vibration-transmission means (31) comprise a washer in a vibration plane which is perpendicular to the longitudinal axis. The washer has:
an outer diameter configured to coincide with a diameter of the inner wall (13);
a housing configured to receive a vibration of the vibration means (30). The housing has an inner diameter that is greater than a maximum dimension of the vibration means (30).

In one specific embodiment, the two eccentric parts are capable of striking each other and the vibration is transmitted to the housing wall.

In another embodiment, the two eccentric parts are capable of striking the housing wall.

Preferably, as shown in FIG. 1 the vibration-transmission means (31) comprise in different locations of the vibration plane:
actuation means (40) to connect/disconnect the vibration means (30);
energy storage means (32) to power the active components of the device, wherein said energy storage means (32) or battery of the device can for instance be charged on a base;
energy reception means (33) to charge the storage means when the device is not being used;
command reception means (34) to control the operation of the vibration means (30), wherein said command reception means (34) can for instance receive remote orders from a control, for the user's comfort.

Preferably, the device of the invention also comprises extraction means (1) to allow extracting the body (2), said extraction means (1) comprising a first end connected to the lower segment (22) of the body (2) and a second end capable of protruding from the vagina (8) to allow the device to be extracted by the user. Said extraction (1) can be a loop or any other element whose length and shape are suitable to facilitate the extraction of the active stimulator after its use. The extraction means (1) can be made of cord, string or similar materials, preferably waterproof.

In another embodiment, the device of the invention also comprises placement means constituted by a mark or recess (23) in the lower segment (22) of the body (2), where the loop insertion is located (1), configured to:
facilitate the correct insertion of the device into the vagina (8), serving as a guide for the insertion of the active perineal stimulator and
house the first end of the extraction means.

Optionally, the body (2) has a shape selected between spherical and ovoid.

Optionally, the vibration of the vibration means (30) is transmitted to the inner wall (13) in an equatorial segment between the upper segment (21) and the lower segment (22).

The material of the body can be a polymeric material intended to be in direct contact with tissues and organs.

1. An active device to stimulate a perineal area, configured to be inserted in a vagina (8) comprising a hollow body (2), said body (2) comprising:
an upper segment (21);
a lower segment (22) which has a longitudinal axis between the upper segment (21) and the lower segment (22);
an inner wall (13);
vibration means (30) to make the inner wall (13) vibrate;
vibration-transmission means (31) to transmit the vibration from the vibration means (30) to the inner wall (13), so that the inner wall (13) is alternatively vibrated by the vibration means (30), wherein
said vibration means (30) comprise two eccentric parts capable of rotating in opposite directions, at equal or close speeds.

2. (canceled)

3. The device according to claim 1, wherein the vibration-transmission means (31) comprise a washer in a vibration plane which is perpendicular to the longitudinal axis, said washer having:
an outer diameter configured to coincide with a diameter of the inner wall (13);
a housing, configured to receive a vibration from the vibration means (30), said housing having an inner diameter that is greater than a diameter of the vibration means (30).

4. The device according to claim 2, wherein the vibration-transmission means (31) comprise in different locations of the vibration plane:
actuation means (40) to connect/disconnect the vibration means (30);
energy storage means (32) to power the active components of the device;
energy reception means (33) to charge the storage means when the device is not being used;
command reception means (34) to control the operation of the vibration means (30).

5. The device according to claim 1, further comprising extraction means (1) to allow extracting the body (2), said extraction means (1) comprising a first end connected to the lower segment (22) of the body (2) and a second end capable of protruding from the vagina (8) to allow the device to be extracted by the user.

6. The device according to claim 1, further comprising placement means constituted by a recess (23) in the lower segment (22) of the body (2) configured to:
facilitate the insertion of the device into the vagina (8) and
house the first end of the extraction means.

7. The device according to claim 1, wherein the body (2) has a shape selected between spherical and ovoid.

8. The device according to claim 1, further comprising a vibration of the vibration means (30) is transmitted to the inner wall (13) in an equatorial segment between the upper segment (21) and the lower segment (22).

9. The device according to claim 2, wherein the two eccentric parts are capable of striking each other so that the vibration is transmitted to the housing wall.

10. The device according to claim 2, wherein the two eccentric parts are capable of striking the housing wall.
